(19) United States
(12) Patent Application Publication
(10) Pub. No.: US 2013/0170889 A1
(43) Pub. Date: Jul. 4, 2013

(54) SURFACE CLEANING, COATING AND SCRATCH FILLING APPARATUS

(71) Applicant: Ken Wilson, San Diego, CA (US)

(72) Inventor: Ken Wilson, San Diego, CA (US)

(21) Appl. No.: 13/625,868

(22) Filed: Sep. 24, 2012

Related U.S. Application Data
(60) Provisional application No. 61/538,104, filed on Sep. 22, 2011.

(51) Int. Cl. B05C 1/00; B08B 1/00

(52) U.S. Cl. CPC B05C 1/00; B08B 1/001
USPC 401/198; 15/104.94

(57) ABSTRACT

The present disclosure generally relates to pocket-sized or key chain size surface cleaning, coating and scratch filling apparatuses. Some of the applications of an embodied apparatus include a tool for cleaning, coating treating or repairing; sunglass/eyeglass, goggles, computer screen, PDA's, smartphones, cell phones, IPods, IPads and/or CDs, DVDs, and/or Bluray disc surfaces.

### BACKGROUND OF THE INVENTION

1. Field of the Invention

The invention relates generally to a surface cleaning, coating and scratch filling apparatus and more specifically to a pocket-size handheld cleaning, coating or scratch filling tool for cleaning or coating eyeglass, goggles, or camera lenses, cell-phones, pda, tablet computers or computer screens, or cleaning coating or gap filing the surfaces of CDs, DVDs or other media discs.

2. Background Information

People are constantly on the go with their busy schedules, and typically are accompanied with a variety of tools for their daily lives including glasses, cellphones, computers, tablets, cds, and dvds all of which require a clean scratch free surface for best results. The present invention provides a tool to maintain each of these tools in their optimal working order, by providing and cleaning, coating and or scratch filling fluid to the surfaces of these tools, and a mechanism for extracting the extra fluid.

### SUMMARY OF THE INVENTION

The present invention relates to pocket-sized or key chain size surface cleaning, coating and scratch filling apparatuses.

Some of the applications of the present invention include but are not limited by the following: sunglass/eyeglass, eye goggles or shields, computer screen, PDA's, smartphones, cell phones, IPods, IPads and/or CDs, DVDs, and Bluray; cleaning, coating with a smudge protector or polarized film or other UV filter, filling in minor cracks, or scratches to create a renewed smooth surface.

Features of embodied devices include a customizable wicking system which matches the density of the foam wick fluid applicator with the density of the fluid to be used such that fluid does not leak from the tip unless the wick is compressed onto the surface of the item to be treated.

Additional features may include a synthetic or natural felted, or shammy type materials including materials similar to those found in the sham-wow type cleaning towels or other highly absorptive materials that can be used as eraser type portion which is capable of removing the excess fluid from the treated surface without leaving streaks or fibers behind. Optional embodiments include the eraser portion that is capable of being retracted into the device to remain clean and protected when not in use.

An embodiment of the present invention comprises an apparatus for cleaning or treating a hard surface comprising; a wick, a wick holder; a body comprising a fluid chamber containing a fluid for cleaning or treating a hard surface. Additional embodiments may include a sliding aperture; an eraser retraction apparatus; an eraser attachment pin; and an eraser. The embodied apparatus may further include a cap or cover for the wick portion. Further additional embodiments may include grip wings and/or serrations on the external body of the apparatus to provide better grip for the user when in use. Yet further embodiments may include anchors or attachment points for keychains, clips, or caribineers.

Another embodied apparatus contemplated in the present invention includes an apparatus for cleaning or treating a hard surface comprising; a wick; a wick holder; a body comprising a fluid chamber containing a fluid for cleaning or treating a hard surface; a pressure release canal; a cap; and an eraser attached to said cap wherein the cap is pressure fitted to the body of the apparatus and the pressure release canal serves the purpose of releasing the vacuum pressure created by removing a tight fitting cap.

Additional features may also include an excess fluid reclamation feature wherein the shammy eraser tip portion is used to collect excess fluid from a user surface and retracted back into the device, wherein either a manual or a vacuum pressure may be provided to extract the excess fluid out of the shammy tip and back into the fluid reservoir.

### BRIEF DESCRIPTION OF THE DRAWINGS

FIG. 1 is an exploded view of embodied device.

FIG. 2 comprises FIGS. 2A-2D wherein FIGS. 2A, B and C show side views of a featured device wherein the fluid extractor tip is in a retracted position and the fluid application tip is covered with a cap and FIG. 2D shows a cut away view wherein the internal components of an embodied device are visible.

FIG. 3 represents the device of FIGS. 1 and 2 with the fluid provider cap removed and the fluid extractor tip in an extended, in use, position.

FIG. 4 represents an alternative device similar to FIGS. 1-3 but has a membrane or cover for the fluid extraction end of the device. FIG. 4 comprises FIG. 4A which shows the fluid extraction portion in the extended, in use, position and FIG. 4B shows the fluid extractor in the retracted, stored, position with the membrane, cover protecting covering the fluid extractor tip.

FIG. 5 represents and alternative device wherein the body of the device further comprises and LED Light source for illuminating an area of interest and a power source and mechanism for turning the LED Light Source on and off.

FIG. 6 represents alternative devices with fluid reclamation features. FIG. 6A represents a device wherein fluid reclamation from the fluid extractor tip is performed via use compression on the cover membrane which forces fluid into a fluid reclamation canal. FIGS. 6B and 6C represent a device with a fluid reclamation feature that includes an internal vacuum or negative pressure feature used to draw the fluid from the fluid extractor tip into a reclamation canal.

FIG. 7 comprises FIG. 7A and FIG. 7B which feature alternate view of another embodied apparatus. FIG. 7A is a perspective view of an embodied device with the cap on, and FIG. 7B is a perspective view of the same device with the cap off and placed on the bottom portion of the apparatus and held into place.

### DETAILED DESCRIPTION OF THE INVENTION

The present invention generally relates to cleaning, coating and scratch filling apparatuses and more specifically to pocket-sized or key chain size surface cleaning, coating and scratch filling apparatuses but may be scaled up to a flashlight or thermos size product if necessary for cleaning or treating large surface areas.

Applications of embodiments of the present invention include but are not limited by the following:

Sunglass/eyeglass, goggle or eye shield; cleaning, coating with a smudge protector or polarized film or other UV filter, filling in minor cracks, or scratches to create a renewed smooth surface.

Computer screen, PDA's, smartphones, cell phones, IPods, IPads and the like; cleaning the surface from smudges, dirt and grime, applying a smudge resistant, antistatic or glare resistant coating and or filling in minor cracks or scratches to restore the smooth surface.

CDs, DVDs, and Bluray orother magnetic disc technology; cleaning the surface from smudges dirt, and hand oils which disrupt function, apply a oil resistant coating and fill in minor scratches which often make the discs unreadable.

Features of embodied devices include a customizable wicking foam system which matches the density of the foam wick fluid applicator with the density of the fluid to be used such that fluid does not leak from the tip unless the wick is compressed onto the surface of the item to be treated. Therefore, when working with a lower viscosity fluid, such as a cleaning fluid the density of the foam used for the wick portion of an embodied device is highly compressed in a range around 10.8 to 13.2 pounds by using a 4 pound density foam and felting it in a 3:1 ratio. When the fluid to be used has a higher viscosity the foam density will be decreased in relation to the fluid viscosity, for example the crack filling fluids are typically of high viscosity and therefore the cell or pore size of the picking foam, or sponge-like material which may be used will be much higher than those used for cleaning fluids.

Materials contemplated for the wick portion include hydrophilic polyester open cell felted foam. Compressed or felted foam is heated and compressed to make the foam more dense. The density is typically measured using the drop ball test in which a steel ball is dropped from a specified height and the compression the steel ball causes is measured. The current wick contemplated for general surface cleaning and coating uses may be around 3.8 to 4 pounds.

Additional features may include a synthetic or natural felted, chamois, or shammy or sham-wow type eraser type portion which is capable of removing the excess fluid from the treated surface. Materials contemplated are any material which is highly absorbent but will not leave streaks or fibers behind. Optional embodiments include the eraser portion that is capable of being retracted into the device to remain clean and protected when not in use.

Additional features may include an LED light and power source, along with various key chain attachment anchors, clips or carabineers.

Additional features may also include an excess fluid reclamation feature wherein the shammy eraser tip portion is used to collect excess fluid from a user surface and retracted back into the device, wherein a vacuum pressure may be provided to extract the excess fluid out of the shammy tip and back into the fluid reservoir via an additional vacuum pressure created when the retraction button is further drawn back.

The following examples are intended to illustrate but not limit the invention.

### Example 1

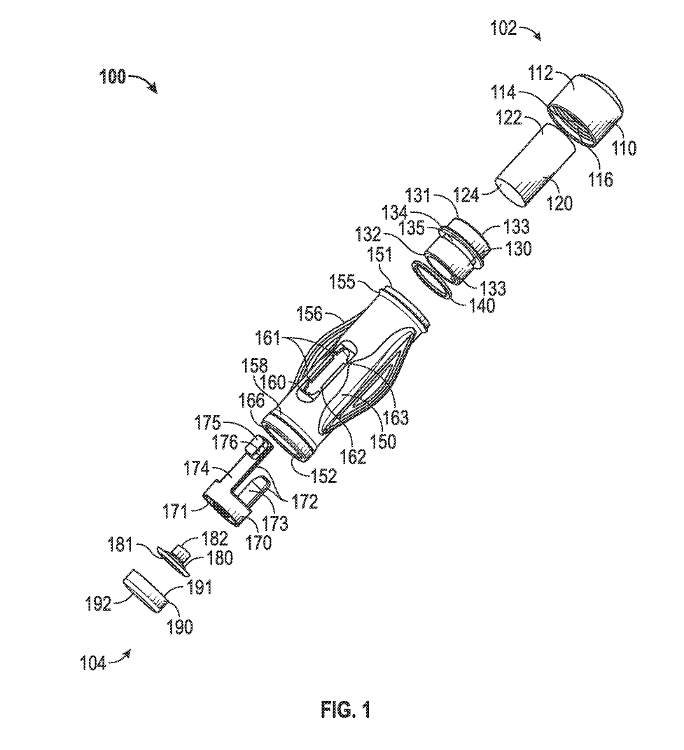

FIGS. 1-3 feature an embodied invention in various views.

Embodiments of the present invention include an apparatus 100 comprising a cap 110 a wick 120 a wick holder 130 a washer 140 a body 150 a sliding aperture 160 an eraser retraction apparatus 170 an eraser attachment pin 180 and an eraser or fluid extractor 190.

FIG. 1 shows an embodied invention 100 having a treatment end 102 and a drying end 104 a wick end closing cap or cover 110 having an external surface 112 and an internal surface 114 the internal surface 114 optionally attach include threading or gaskets 116 to provide either a pressure fitting (like a chap-stick cap) or a threaded screw type attachment to the body 150 of the apparatus 100. An embodied apparatus 100 also contains a wick 120 comprising a treatment interface end 122 and a fluid absorption end 124. The wick 120 may be made of a variety of foams, discussed above, and the right wick 120 to use for a specific treatment will be based on the density properties of the foam wick 120 and the viscosity of the treatment fluid (not shown) to be used. Additionally, an embodied invention 100 comprises a wick holder 130 which comprises a treatment end 131 a chamber end 132, a wick holding aperture 133 wherein the wick 120 extends through on both the treatment end 131 and the chamber end 132. The wick holder 130 additionally comprises a chamber sealing rim 134 and a washer groove 135 wherein a washer or other sealing apparatus 140 is placed to secure a liquid impermeable seal between the body 150 and the wick holder 130. The body 150 comprises a wick end opening 151 an eraser end opening 152 and a wick fluid chamber 153 (not shown). Within the internal structure of the body 150 there is a wick stop peg 154 (not shown) which prevents the wick 120 from compressing too deeply or bottoming out within or into the wick fluid chamber 153 (not shown). On the external surface of the body 150 around the wick end opening 151 there is a body wick holder rim 155 which interfaces with the cap 110 and maintains a snug fit either by pressure molded or further comprises matching threading with the cap 110 so that the cap 110 can be secured to the body 150 and protect the wick 120. The external surface of the body 150 may also comprise one or more textured or grip enhancing features such as grip wings and/or serrations 156 which enable the user to more securely grasp the apparatus 100 especially when working in slippery conditions. Additionally, the external surface of the body 150 may include an attachment means or an anchor for an attachment means 157, with examples being a key chain holder or belt or caribineer clip mechanism. Around the eraser and opening 152 there may be an eraser cap rim 158 which may optionally interface with an eraser opening membrane 159 (not shown) and/or an eraser cap 169 (not shown). Embodiments of an apparatus 100 contemplated in the present invention include an apparatus 100 wherein the body 150 further comprises a sliding aperture 160 extending from the external surface of the body 150 into the inner surface of the body 150 the sliding aperture 160 comprises a female mating grooves 161 placed at two positions or more positions when the mating grooves are at the extended position 162 an eraser 190 is extended from the body 150 of the apparatus 100 and is in a usable position for drying or absorbing excess fluid from a treated area. When the mating grooves are in the retracted position 163 the eraser 190 is retracted within the body 150 of the apparatus 100 in an eraser housing chamber 166. The eraser 190 is retracted and extended in and out of the housing chamber 166 by means of an eraser sliding holder 170 which comprises and eraser holder attachment aperture 171 which interfaces with an eraser attachment pin 180 to secure an eraser 190 to the eraser sliding holder 170. The eraser sliding holder 170 additionally comprises two structure arms 172 which help maintain the structural integrity of the eraser holder 170 within the body 150 of the apparatus. The two structure arms 172 have one shorter arm 173 located on the opposite of the sliding aperture 160, and a longer structure arm 174 which has a thumb depression button 175 and accompanying male mating protrusions 176 located near the end of the longer arm 174. The thumb depression button 175 resides within the sliding aperture 160 and the male mating protrusions 176 mate with the female mating grooves 161 to secure the eraser in either a retracted or user position. To disengage the mating process of 1 the protrusions 176 and grooves 161 the thumb depress button 175 is pressed inward into the body 150 of the apparatus until the protrusions 176 clear the grooves 161 and then the eraser sliding holder 170 can move freely from one end to another. The eraser attachment pin 180 comprises an eraser pin attachment surface 181 which attaches to the attachment surface 191 of an eraser 190 and an attachment pin/eraser holder interface 182 which secures the attachment pin 190 to the eraser holder 170. The eraser 190 additionally features a drying or user surface 192 which interacts with the fluid to be absorbed.

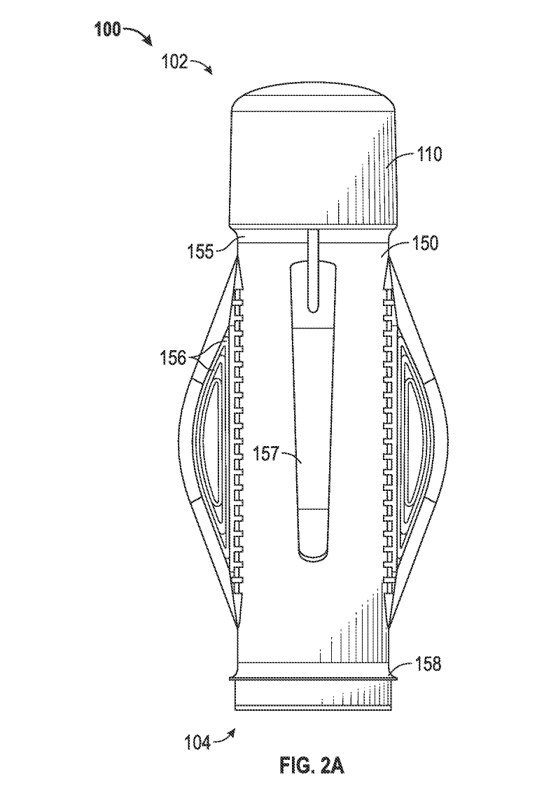

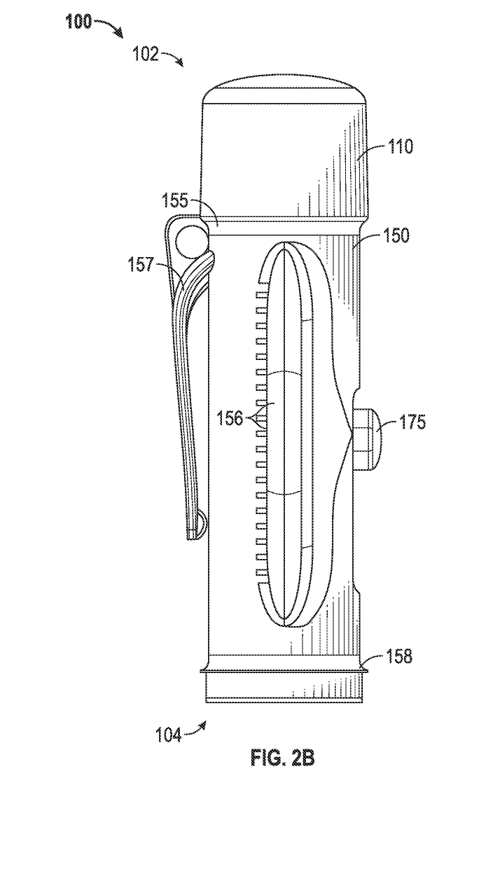

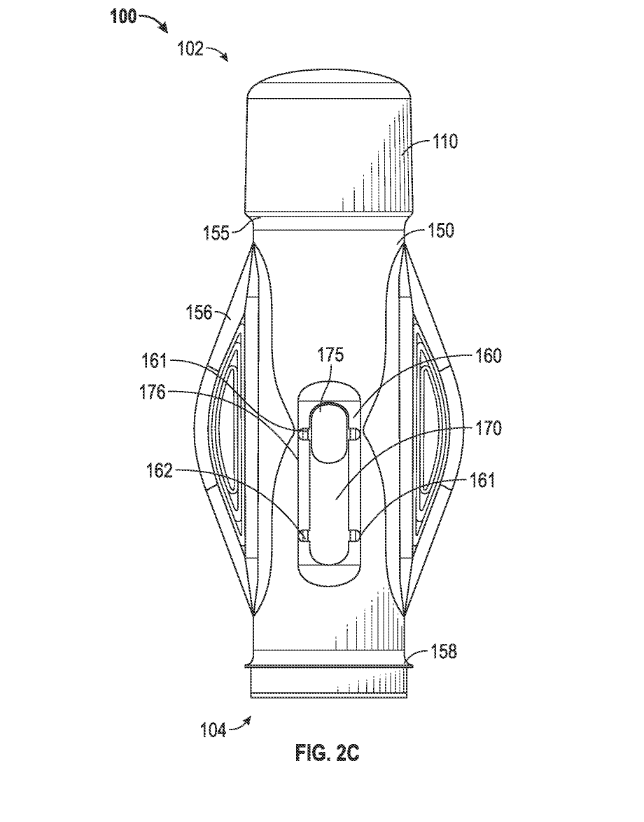

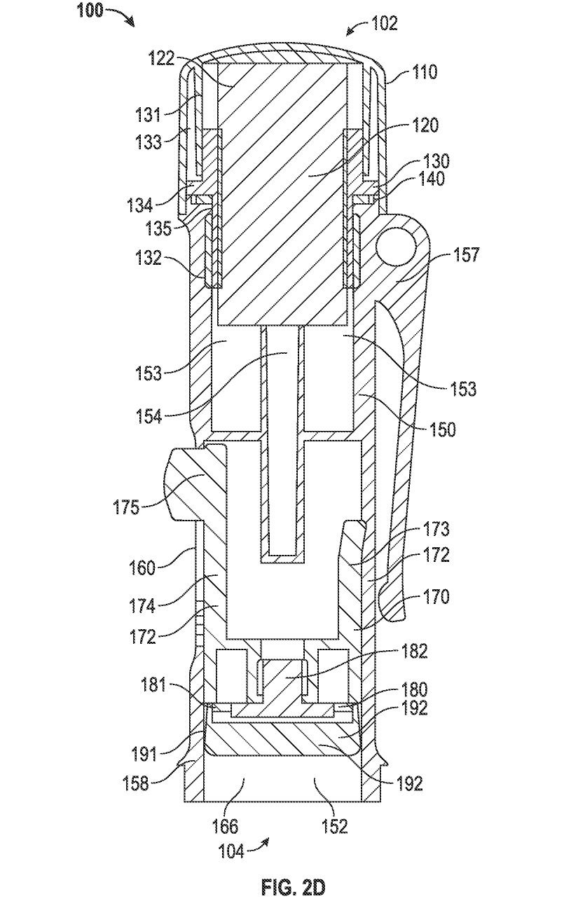

FIG. 2 generally comprises FIGS. 2A-2D wherein FIGS. 2A, B and C show side views of a featured device wherein the fluid extractor/eraser tip 190 is in a retracted position and the fluid application tip 122 is covered with a cap 110 and FIG. 2D shows a cut away view wherein the internal components of an embodied device are visible. More specifically FIG. 2A shows the featured device of FIG. 1 wherein an attachment means 157 is shown attached to the body 150 of the apparatus 100 as a clip. Additionally, grip enhancers 156 including both serrations and grip wings are clearly visible. FIG. 2B represents an additional side view wherein the thumb depression button 175 is clearly shown as well a clip type attachment means 157. FIG. 2C shows another side view wherein the sliding aperture 160 is clearly visible and the male mating protrusions 176 are shown engaged within the female mating grooves 161 at the retracted position 163 and in relation to the thumb depress button 175. FIG. 2D shows a cut away view wherein the previously unviewable components are now featured. Mainly, the relationship of the wick fluid chamber 153 is shown wherein the wick stop peg 154 is featured and is responsible fro preventing the wick 120 from compressing all the way into the fluid chamber 153. Additionally, the way the eraser tip 190 is housed within the eraser end opening 152 and eraser housing chamber 166 is clearly visible.

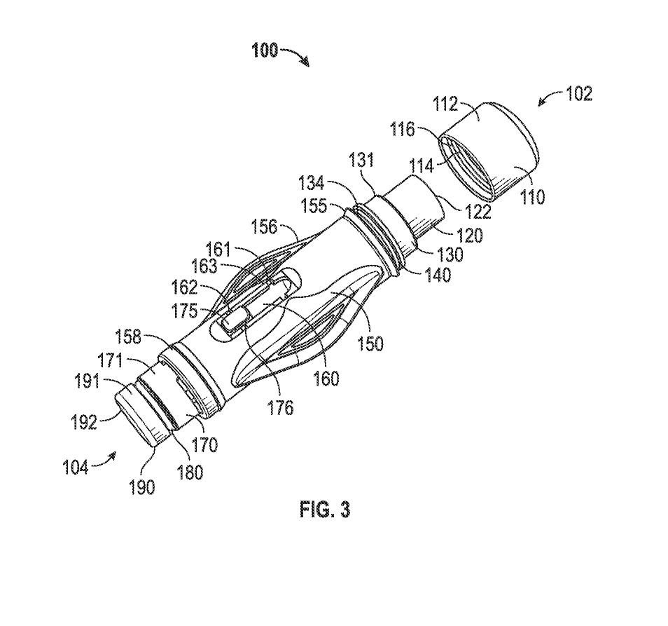

FIG. 3 represents the device of FIGS. 1 and 2 with the fluid provider cap 110 removed and the fluid extractor tip 190 in an extended, in use, position 162. And the relationship of the components previously identified is made more clear.

### Example 2

### Membrane Eraser Cover Features

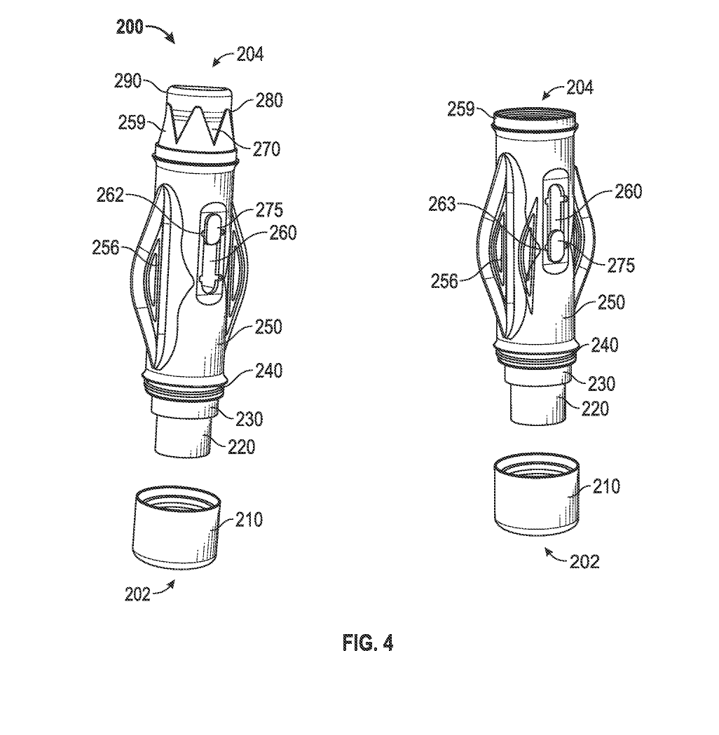

FIG. 4 represents an alternative device similar to FIGS. 1-3 but has a membrane or cover 258 for the fluid extraction end 290 of the device 200. FIG. 4 comprises the same apparatus wherein the fluid extraction portion 190 is in the extended, in use, position 262 on the left side and shows the fluid extractor in the retracted, stored, position 263 with the membrane, cover 259 protecting and covering the fluid extractor tip 290 on the right side. The numbers in relation to components are maintained consistent for each embodied device with only the first number represent differing devices for example the body may be listed as 150 in the first described apparatus 100 and as body 250 in the second identified apparatus 250 and so on.

### Example 3

### LED Illuminating Features

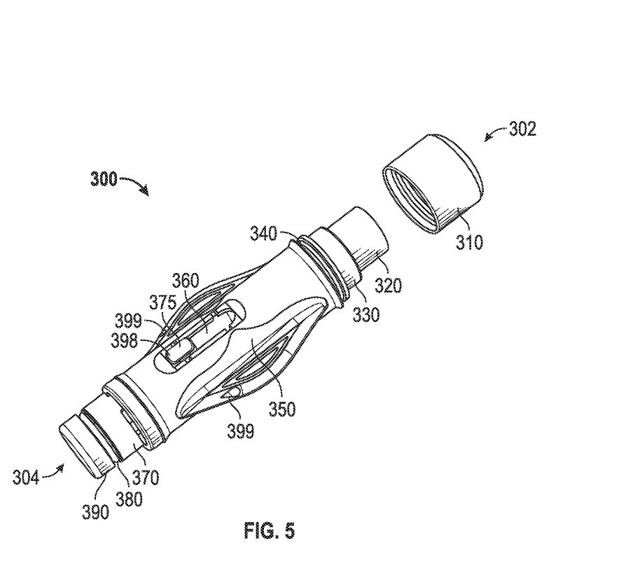

FIG. 5 represents an alternative device 300 similar to the embodied apparatus of FIGS. 1-3 wherein the body of the device further comprises an LED Light source 399 for illuminating an area of interest and a power source (not shown) and mechanism for turning the LED Light Source on and off 398 shown here as connecting with the thumb depress button 375 wherein when the thumb depress button 375 is depressed it can interact with the power source (not shown) and result in the illumination of the LED light source 399. The Light Source on/off mechanism 398 may optionally be placed within the grip wings 356.

### Examples 4 and 5

### Fluid Reclamation Features

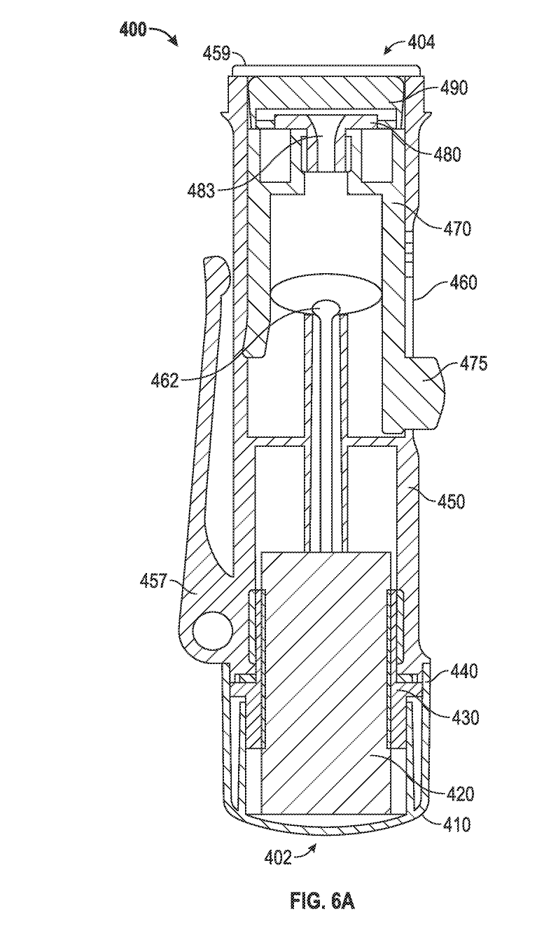

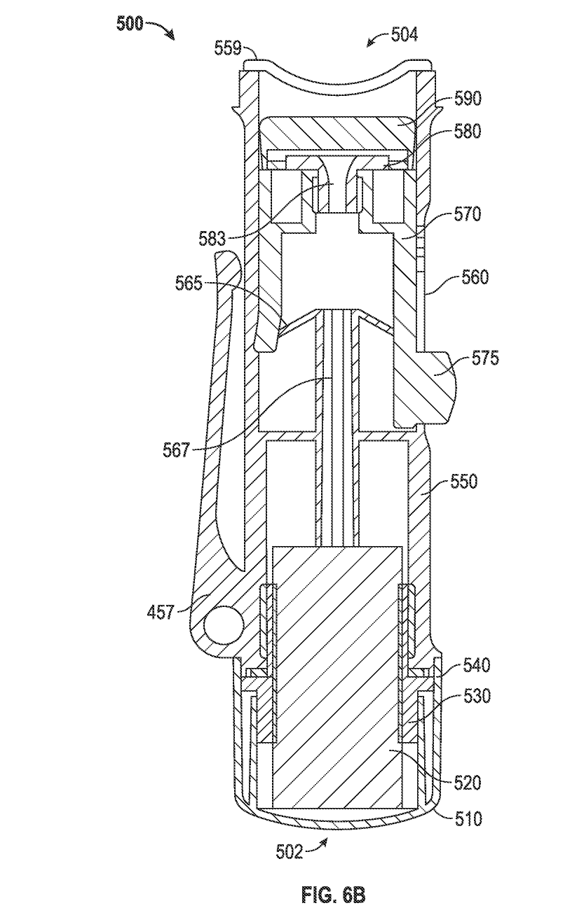

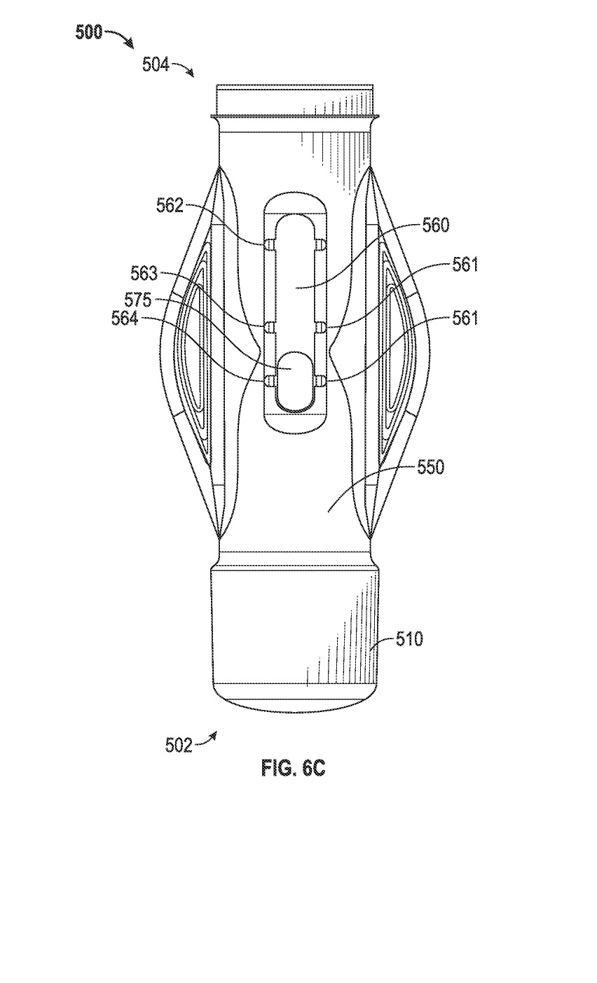

FIG. 6 represents alternative devices with fluid reclamation features. FIG. 6A represents a device 400 wherein fluid reclamation from the fluid extractor tip 490 is performed via user compression on the cover membrane 459 which forces fluid through a pin fluid reclamation aperture 483 within an eraser attachment pin 480 and into a fluid reclamation canal 467 which leads back to the wick fluid chamber 453 so that excess treatment fluid may be reclaimed and reused. FIGS. 6B and 6C represent a device 500 with a fluid reclamation feature that includes an internal vacuum or negative pressure feature shown as a membrane 565 used to draw the fluid from the fluid extractor tip 590 into a reclamation canal 567. A negative pressure system is created within the body 550 of the apparatus 500 by drawing back the membrane 565 beyond the retraction position 563 to a negative pressure position 564 wherein the membrane stretches back upon further retraction into the position 574 and creates a negative pressure pull within the body 550 of the apparatus 500 and draws the fluid from the eraser 590 through a pin fluid reclamation aperture 583 within an eraser attachment pin 580 and into a fluid reclamation canal 467 which leads back to the wick fluid chamber 553.

### Example 6

### Pressure Release Groove

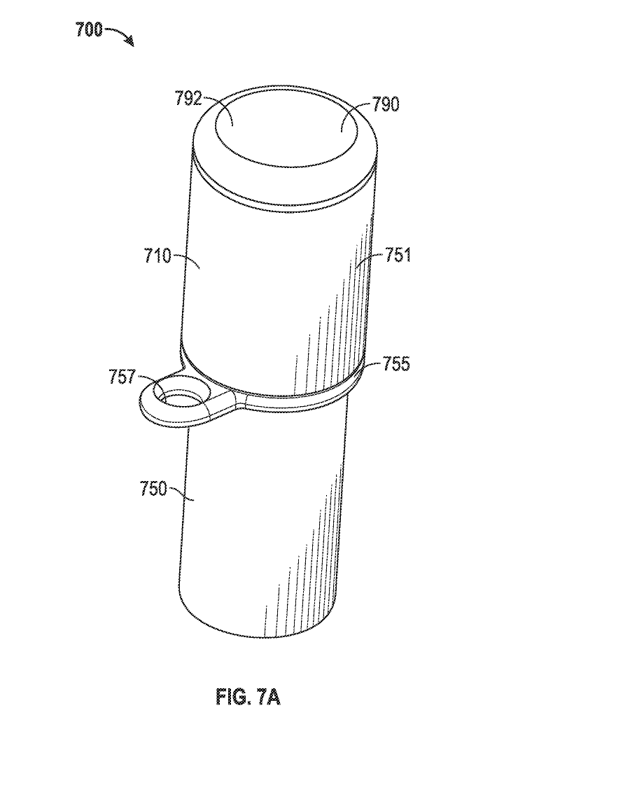

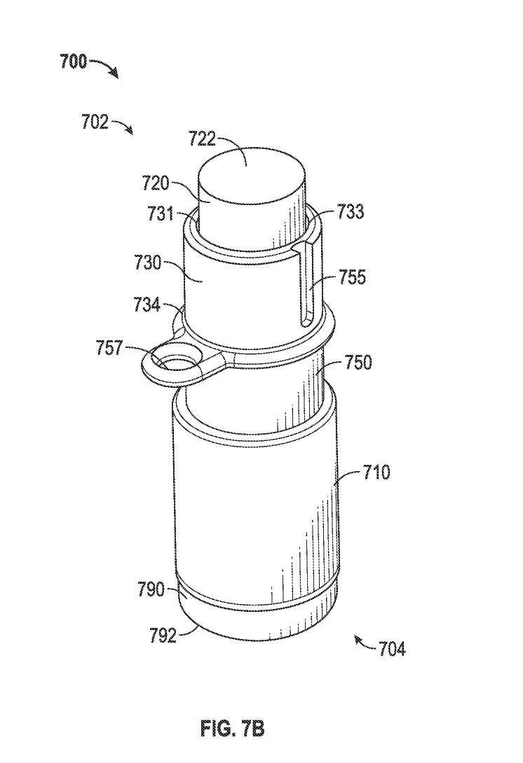

FIG. 7 comprises FIG. 7A and FIG. 7B which shows an embodied invention 700 with a cap 710 on in FIG. 7A and off in FIG. 7B. The embodied invention 700 has a treatment end 702 and a drying end 704 a wick end closing cap or cover 710 having an external surface 712 and an internal surface 714 (not shown) the internal surface 714 optionally attach include threading or gaskets 716 to provide either a pressure fitting (like a chap-stick cap) or a threaded screw type attachment to the body 750 of the apparatus 700. An eraser 790 also is attached to the external surface 712 of the cap 710 at the top of the cap 710. An embodied apparatus 700 also contains a wick 720 comprising a treatment interface end 722 and a fluid absorption end 724 (not shown). The wick 720 may be made of a variety of foams, discussed above, and the right wick 720 to use for a specific treatment will be based on the density properties of the foam wick 720 and the viscosity of the treatment fluid (not shown) to be used. Additionally, an embodied invention 700 comprises a wick holder 730 which comprises a treatment end 731 a chamber end 732 (not shown), a wick holding aperture 733 wherein the wick 720 extends through on both the treatment end 731 and the chamber end 732. The wick holder 730 additionally comprises a chamber sealing rim 734 and a pressure release groove 737 wherein the release groove 737 provides for a decrease in pressure to the wick when the cap 710 is pulled off, the release groove 737 takes pressure off of the wick 720 and avoids the wick 720 from being pulled from its position by vacuum forces when the cap 710 is removed. The body 750 comprises a wick end opening 751 and an opposing end 752 wherein the cap or cover 710 with the eraser 790 attached to the top of the cap 710 is placed when the apparatus 700 is in use. The body 750 further comprises a wick fluid chamber 753 (not shown). Within the internal structure of the body 750 there is a wick stop peg 754 (not shown) which prevents the wick 720 from compressing too deeply or bottoming out within or into the wick fluid chamber 753 (not shown). On the external surface of the body 750 around the wick end opening 751 there is a body wick holder rim 755 which interfaces with the cap 710 and maintains a snug fit by pressure molding with the cap 710 so that the cap 710 can be secured to the body 750 and protect the wick 720. The external surface of the body 750 may include an attachment means or an anchor for an attachment means 757, with examples being a key chain holder or belt or caribineer clip mechanism. The eraser 790 additionally features a drying or user surface 792 which interacts with the fluid to be absorbed.

The present invention generally relates to cleaning, coating and scratch filling apparatuses and more specifically to pocket-sized or key chain size surface cleaning, coating and scratch filling apparatuses but may be scaled up to a flashlight or thermos size product if necessary for cleaning or treating large surface areas.

Although the invention has been described with reference to the above example, it will be understood that modifications and variations are encompassed within the spirit and scope of the invention. Accordingly, the invention is limited only by the following claims.

What is claimed is:

1. An apparatus for cleaning or treating a hard surface comprising;
a wick;
a wick holder;
a body;
wherein the body further comprises a fluid chamber containing a fluid for cleaning or treating a hard surface;
a sliding aperture;
an eraser retraction apparatus;
an eraser attachment pin; and
an eraser.

2. The apparatus of claim 1 further comprising a cap or cover for the wick portion.

3. The apparatus of claim 1 further comprising grip wings and/or serrations on the external body of the apparatus to provide better grip for the user when in use.

4. The apparatus of claim 1 further comprising anchors or attachment points for keychains, clips, or caribineers.

5. The apparatus of claim 1 further comprising a cap or cover for the eraser portion.

6. The apparatus of claim 1 further comprising a LED light and a power source.

7. The apparatus of claim 1 wherein various wicks of different foam densities are supplied and matched with the viscosity of the treatment fluid.

8. The apparatus of claim 1 further comprising a fluid reclamation feature.

9. The fluid reclamation feature of claim 8 wherein the feature requires a manual compression onto the eraser to squeeze excess fluid back into a fluid reclamation channel.

10. The fluid reclamation feature of claim 8 wherein excess fluid is drawn out of the eraser and into a fluid reclamation channel via a vacuum or negative pressure created within the body of the apparatus.

11. An apparatus for cleaning or treating a hard surface comprising;
a wick;
a wick holder;
a body;
wherein the body further comprises a fluid chamber containing a fluid for cleaning or treating a hard surface;
a pressure release canal;
a cap; and
an eraser attached to said cap.

12. The apparatus of claim 11, wherein the cap is pressure fitted to the body of the apparatus and the pressure release canal serves the purpose of releasing the vacuum pressure created by removing a tight fitting cap.

13. The apparatus of claim 11 further comprising anchors or attachment points for keychains, clips, or caribineers.
